(19) United States
(12) Patent Application Publication
(10) Pub. No.: US 2025/0143279 A1
(43) Pub. Date: May 8, 2025

(54) Portable Mosquito Trap

(71) Applicant: Shenzhen Visson Technology Co., Ltd., Shenzhen (CN)

(72) Inventors: Xuexun ZHOU, Shanghai (CN); Jiaojiao Du, Nanchong (CN)

(73) Assignee: Shenzhen Visson Technology Co., Ltd., Shenzhen (CN)

(21) Appl. No.: 18/386,608

(22) Filed: Nov. 3, 2023

(51) Int. Cl. A01M 1/14

(52) U.S. Cl. CPC A01M 1/145

(57) ABSTRACT

The present invention discloses a portable mosquito trap, which comprises a seat body, wherein a slot part for installing a sticky board is arranged on the seat body; a storage chamber is arranged in the seat body; the seat body is provided with a bait emitting hole which is close to the slot part; the seat body is provided with a ultraviolet lamp source. In this solution, when in use, bait is placed in the storage chamber; at the same time, a ultraviolet lamp source is arranged on the seat body; then, the sticky board is arranged on the seat body through the slot part, which can effectively improve the effect of attracting mosquitoes and improve the efficiency of killing mosquitoes.

### TECHNICAL FIELD

The present invention relates to the field of insect traps, in particular to a portable mosquito trap.

### BACKGROUND

The solution attracts mosquitoes by light, which improves the efficiency of catching mosquitoes to a certain extent. However, due to the limited means of attracting mosquitoes, the efficiency of catching mosquitoes is still limited, and the solution can only be used in scenes with sockets and cannot be taken out. Therefore, it is necessary to design a portable product with various attractive means to improve the efficiency of catching mosquitoes.

### SUMMARY

The present invention provides a portable mosquito trap, which includes a seat body with an accommodating cavity, wherein a slot part is arranged on the seat body, and the slot part is used for installing a sticky board coated with an adhesive.

more than one storage chamber for containing bait is arranged in the seat body; the seat body is provided with a bait emitting hole communicated with the storage chamber, and the storage chamber and the bait emitting hole are arranged close to the slot part; the seat body is provided with more than one ultraviolet lamp source for attracting mosquitoes.

In the above solution, the storage chamber for holding the bait is arranged on the seat body, and the bait is placed in the storage chamber when in use; at the same time, a ultraviolet lamp source is arranged on the seat body; then the seat body is provided with a sticky board coated with an adhesive through the slot part, which can effectively improve the effect of attracting mosquitoes and the efficiency of killing mosquitoes.

The present invention also provides a portable mosquito trap, which includes a seat body with an accommodating cavity, wherein a movable slot part is arranged on the seat body, and the slot part is used for installing a sticky board coated with an adhesive, and a bait and the adhesive are mixed together; the seat body is provided with more than one ultraviolet lamp source for attracting mosquitoes, and the ultraviolet lamp sources are arranged around the slot part.

According to the solution, by mixing the bait and the adhesive together, mosquitoes can be directly attracted by the sticky board and adhered; then the ability to attract mosquitoes is further improved by setting the ultraviolet lamp source, so as to improve the efficiency of killing mosquitoes.

The present invention also provides a portable mosquito trap, which includes a seat body with an accommodating cavity, wherein a movable slot part is arranged on the seat body, and the slot part is used for installing a sticky board coated with an adhesive; a bait for attracting mosquitoes is arranged on the sticky board; the seat body is provided with more than one ultraviolet lamp source and a heating source for attracting mosquitoes, and the ultraviolet lamp source is arranged around the slot part; the heating source is used for heating the seat body and the sticky board.

In the above solution, the storage chamber for holding the bait is arranged on the seat body, and the bait is placed in the storage chamber when in use; at the same time, a ultraviolet lamp source and a heating source are arranged on the seat body; then, a sticky board coated with an adhesive is arranged on the seat body through the slot part, and a bait for attracting mosquitoes is arranged on the sticky board; It can further improve the effect of attracting mosquitoes and the efficiency of killing mosquitoes.

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

### BRIEF DESCRIPTION OF DRAWINGS

In order to explain the technical solution of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic diagram of the overall structure of a first embodiment of the present invention.

FIG. 2 is a schematic view of the overall structure of the first embodiment of the present invention from another perspective.

FIG. 3 is a schematic diagram of the exploded structure of the first embodiment of the present invention.

FIG. 4 is a schematic diagram of the exploded structure of the second embodiment of the present invention.

FIG. 5 is a schematic diagram of the exploded structure of the third embodiment of the present invention.

In the figures: Seat body, 1; Upper seat body, 10; Lower seat body, 11; Bait emitting hole, 100; Infrared heating ring 13; Anti-skid pad, 110; Slot part, 2; Installation part, 20; First slot part, 21; Second slot part, 22; Sticky board, 3; Slot, 200; Positioning protrusion, 23; Rotating seat, 25; Positioning groove, 30; Storage chamber, 4; Positioning groove, 40; Ultraviolet lamp source, 5; PCB board, 6; Charging connector, 61; Power switch, 62; Illuminating lamp, 7; Button, 8; Cover plate, 9; Ball head, 90.

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that people having ordinary skills in art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or laver, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

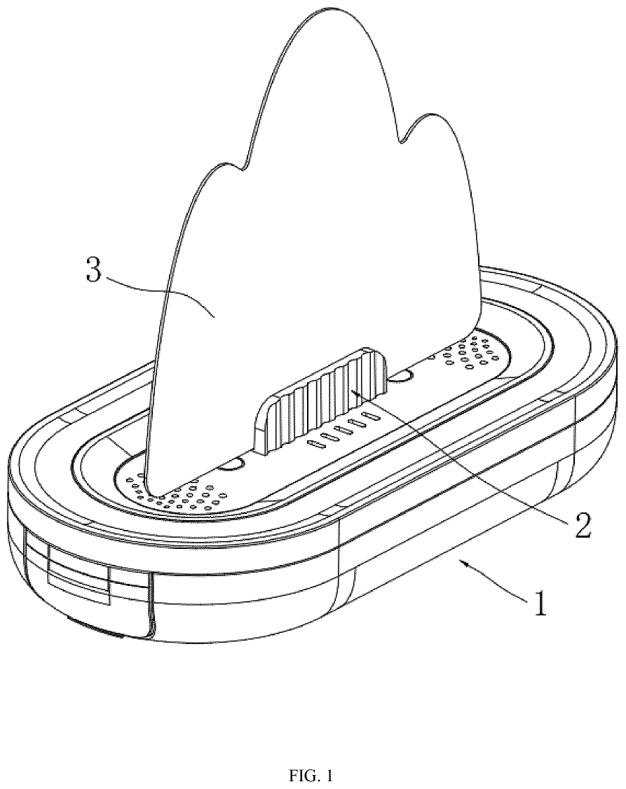

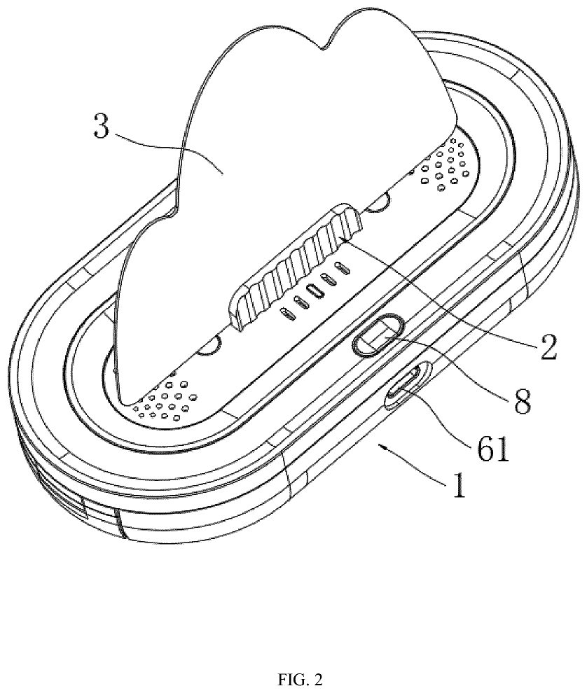

As shown in FIGS. 1 to 3, a portable mosquito trap includes seat body 1 having an accommodating cavity.

In this embodiment, the seat body 1 includes an upper seat body 10 and a lower seat body 11, which are detachably connected, and the accommodating cavity is formed between the upper seat body 10 and the lower seat body 11, and the upper seat body 10 and the lower seat body 11 are connected by screws; the bottom of the lower seat body 11 is also provided with an anti-skid pad 110 for anti-skid.

Of course, the connection mode between the upper seat body 10 and the lower seat body 11 is not limited to the threaded connection mode, and the upper seat body 10 and the lower seat body 11 can be closely combined by a snap connection mode.

Slot part 22 is movably arranged on seat body 1, and slot part 2 is used for installing the sticky board 3 coated with an adhesive.

In this embodiment, the slot part 2 includes a first slot part 21 and a second slot part 22, and the sticky board 3 is clamped by the first slot part 21 and the second slot part 22. Since the sticky board 3 is usually made of paper and has certain compressibility, it is only necessary to reserve a distance between the first slot part 21 and the second slot part 22 that is less than the thickness of the sticky board 3, and when placing the sticky board 3, the sticky board 3 should be pressed hard. Of course, to have a better clamping effect of the slot part 2, elastic pieces can be arranged on the opposite surfaces of the first slot part 21 and the second slot part 22.

The slot 200 formed by the first slot part 21 and the second slot part 22 of the slot part 2 is straight. Of course, the shape of the slot 200 is not limited to straight, and it can be S-shaped, L-shaped and other desired line shapes; it may also be triangular, rectangular, circular, oval, circular and other closed shapes; similarly, the sticky board 3 can also be of various shapes matching with the above clamping groove. When the sticky board 3 is of a circular shape, the surface area of the sticky board increases, and more mosquitoes can be adhered.

The adhesive can be coated on one side or both sides of the adhesive sheet 3 as required.

Slot 200 may be perpendicular to seat body 1 or inclined at an angle with respect to the seat body 1.

Even, a sticky board installation boss can be arranged on the top of the slot part 2, and an installation hole matched with the sticky board installation boss can be formed on the sticky board 3, and the sticky board 3 can be laid flat on the top of the slot part 2.

In this embodiment, a positioning protrusion 23 for positioning the sticky board 3 is arranged between the first slot part 21 and the second slot part 22, and the positioning protrusion 23 extends from the top of the slot part 2 to the bottom of the slot part 2. The sticky board 3 is provided with a positioning groove 30, and when the sticky board 3 is installed, the positioning groove 30 is clamped into the positioning protrusion 23.

There is more than one storage chamber 4 for holding the bait in seat body 1. In this embodiment, there are two storage chambers 4, which are respectively arranged at both ends of the seat body 1 along the length direction. The storage chamber 4 is a drawer structure, and it is connected with the seat body 1 by pushing and pulling. Usually, because of its small size and light weight, it is not necessary to set a sliding track between seat body 1 and the storage chamber 4. Of course, a sliding track can also be set between seat body 1 and the storage chamber 4 to improve the push-pull effect.

The storage chamber 4 is provided with a positioning groove 40, and the lower seat body 11 is provided with a positioning projection (not shown) matched with the positioning groove 40, so that the storage chamber 4 is reliably fixed after being pushed into the lower seat body 1 and is not easy to slide out.

The upper seat body 10 is provided with a bait emitting hole 100 communicating with the storage chamber 4, and the storage chamber 4 and the bait emitting hole 100 are arranged near the slot part 2.

In this embodiment, the bait emitting hole 100 on the upper seat body 10 is located right above the storage chamber 4 and just below the sticky board 3, so that the smell of bait can be emitted around the sticky board 3, and mosquitoes are more likely to be adhered to the sticky board 3.

The setting of the storage chamber 4 is not only the above-mentioned way, but also an opening communicated with the accommodating cavity can be opened on the upper seat body 10. The lower seat body 11 is provided with a chamber for accommodating bait to form a storage chamber; it is also possible to put the formed storage chamber into the accommodating cavity through the opening; as an optimization, a cover plate with bait emitting holes can be arranged at the opening to cover the opening, prevent foreign objects from falling into the storage chamber, and improve the aesthetic effect.

The bait placed in the storage chamber 4 can be one or more, and placing a plurality of baits at the same time can attract a variety of mosquitoes, such as fruit flies and mosquitoes at the same time.

The shape of the bait can be any desired shape, such as round flake, square flake, capsule, etc.

Baits can be stored in a centralized way or separately. When stored in a centralized way, a plurality of bait can be stored in a container in a sealed way, and when used, a single bait can be taken out and placed in storage chamber 4. When a single bait is stored, it is packaged separately in an inner packaging bag and then in an outer packaging bag. When in use, the outer packaging bag is opened and the bait with the inner packaging bag is taken out. The inner packaging bag can be breathable or airtight. When the inner packaging bag is airtight, it is necessary to open the inner packaging bag again and take out the bait and put it in storage chamber 4. Adjacent inner packaging bags can be arranged in a shape convenient for tearing, such as zigzag.

The seat body 1 is provided with more than one ultraviolet lamp source 5 for attracting mosquitoes, and the ultraviolet lamp source 5 can emit ultraviolet lamp of about 365 nanometers to attract mosquitoes.

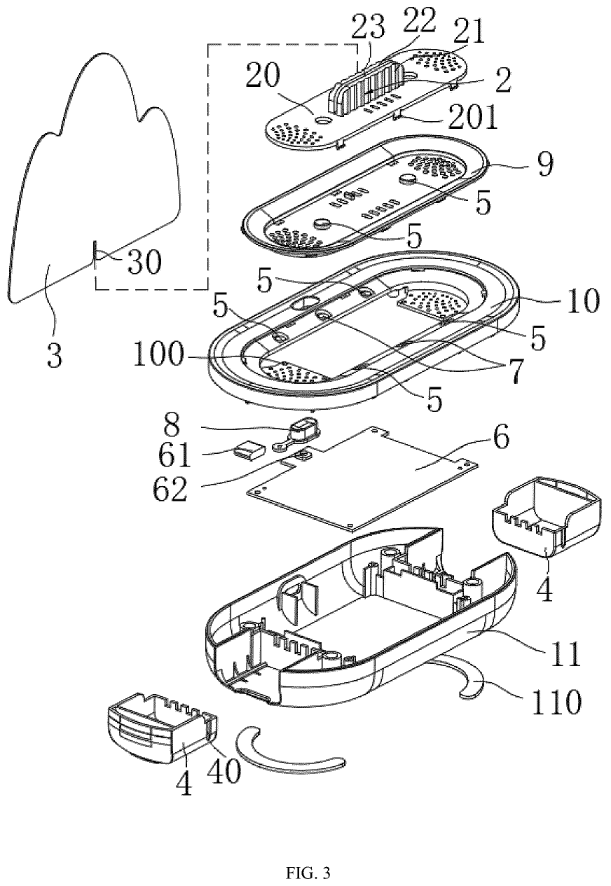

In this embodiment, to achieve the best mosquito attraction effect, six ultraviolet lamp sources 5 are arranged around the slot part 2, and the specific positions are shown in FIG. 3.

A PCB board 6 is also arranged in the accommodating cavity, and the ultraviolet lamp source 5 is electrically connected with the PCB board 6. The ultraviolet lamp source 5 can be arranged on the upper seat body 10 or directly on the PCB board 6, and the ultraviolet lamp source 5 only needs to extend out of the upper seat body 10.

The seat body 1 is also provided with more than one illuminating lamp 7, which is electrically connected with the PCB board 6, and the PCB board 6 is also provided with a charging connector 61 and a power switch 62. A storage battery (not shown) electrically connected with the PCB board 6 is also provided in the accommodating cavity.

The upper seat body 10 is provided with a button 8 for pressing a power switch 62.

In this embodiment, for the sake of beauty, a cover plate 9 which can transmit the light emitted by the ultraviolet lamp source 5 and the illuminating lamp 7 is also arranged on the upper part of the upper seat body 10, and the cover plate 9 is connected with the upper seat body 10 through threads or buckles.

In this embodiment, in order to more conveniently arrange the slot part 2, an outwardly extending installation part 20 is arranged at the bottom of the slot part 2, and a buckle 201 is arranged on the installation part 20, and the slot part 2 is connected with the cover plate 9 through the installation part 20.

Both the installation part 20 and the cover plate 9 are provided with air holes communicating with the bait emitting holes 100.

In this solution, the storage chamber 4 is set to facilitate replenishing bait, and the drawer-type storage chamber 4 is simple in structure and convenient to operate; the odor emitted by the bait can be emitted to the periphery of the sticky board 3 through the bait emitting hole 100, and the effect of attracting mosquitoes is good; the sticky board 3 is clamped by the first slot part 21 and the second slot part 22, and the sticky board 3 can be replaced by plugging and unplugging, which is very convenient; by arranging a plurality of ultraviolet lamp sources 5 around the slot part 2, the ultraviolet lamp sources 5 can attract mosquitoes by emitting ultraviolet light, thus achieving a better mosquito killing effect; the illuminating lamp 7 can achieve the effects of lighting and ambient light, and the switch 62 can switch different modes as needed to realize multiple functions. The battery in seat body 1 is charged through the charging connector 61, so the mosquito trap can be carried out and is suitable for outdoor scenes such as camping.

### Example 2

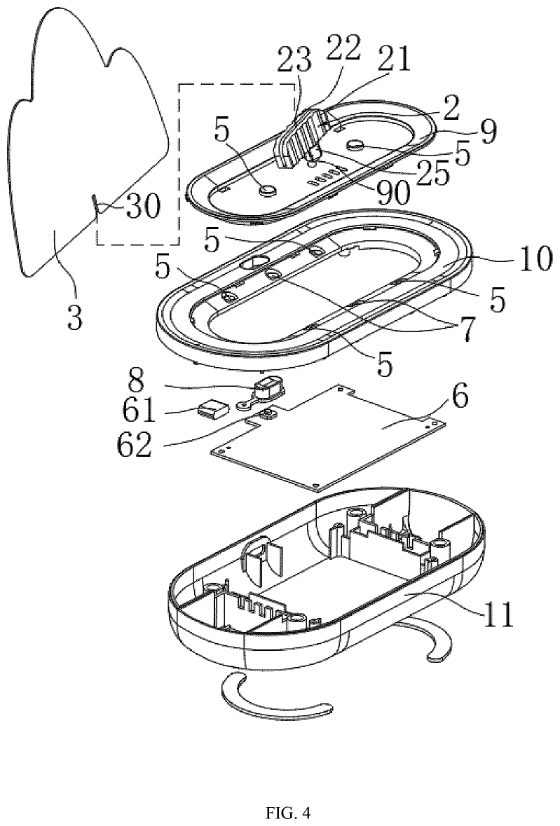

As shown in FIG. 4, a portable mosquito trap includes seat body 1 having an accommodating cavity.

In this embodiment, the seat body 1 includes an upper seat body 10 and a lower seat body 11, which are detachably connected, and the accommodating cavity is formed between the upper seat body 10 and the lower seat body 11, and the upper seat body 10 and the lower seat body 11 are connected by screws; the bottom of the lower seat body 11 is also provided with an anti-skid pad 110 for anti-skid.

Of course, the connection mode between the upper seat body 10 and the lower seat body 11 is not limited to the threaded connection mode, and the upper seat body 10 and the lower seat body 11 can be closely combined by a snap connection mode.

Slot part 22 is movably arranged on seat body 1, and slot part 2 is used for installing the sticky board 3 coated with an adhesive.

In this embodiment, the slot part 2 includes a first slot part 21 and a second slot part 22, and the sticky board 3 is clamped by the first slot part 21 and the second slot part 22. Since the sticky board 3 is usually made of paper and has certain compressibility, it is only necessary to reserve a distance between the first slot part 21 and the second slot part 22 that is less than the thickness of the sticky board 3, and when placing the sticky board 3, the sticky board 3 should be pressed hard. Of course, to have a better clamping effect of the slot part 2, elastic pieces can be arranged on the opposite surfaces of the first slot part 21 and the second slot part 22.

The slot 200 formed by the first slot part 21 and the second slot part 22 of the slot part 2 is straight. Of course, the shape of the slot 200 is not limited to straight, and it can be S-shaped. L-shaped and other desired line shapes, and it may also be round, oval, circular and other closed shapes; similarly, the sticky board 3 can also be of various shapes matching with the above clamping groove. When the sticky board 3 is of a circular shape, the surface area of the sticky board increases, and more mosquitoes can be adhered.

Slot 200 may be perpendicular to the seat body 1 or inclined at an angle with respect to the seat body 1.

Even, a sticky board installation boss can be arranged on the top of the slot part 2, and an installation hole matched with the sticky board installation boss can be formed on the sticky board 3, and the sticky board 3 can be laid flat on the top of the slot part 2.

In this embodiment, a positioning protrusion 23 for positioning the sticky board 3 is arranged between the first slot part 21 and the second slot part 22, and the positioning protrusion 23 extends from the top of the slot part 2 to the bottom of the slot part 2. The sticky board 3 is provided with a positioning groove 30, and when the sticky board 3 is installed, the positioning groove 30 is clamped into the positioning protrusion 23.

As part of the bait will volatilize completely after being left for a long time, in this embodiment, the bait and adhesive are mixed, which can simplify the structure of the solution and reduce the production cost.

In this embodiment, for the sake of beauty, a cover plate 9 which can transmit the light emitted by the ultraviolet lamp source 5 and the illuminating lamp 7 is also arranged on the upper part of the upper seat body 10, and the cover plate 9 is connected with the upper seat body 10 through threads or buckles.

In this embodiment, the slot part 2 is connected with the seat body 1 through an angle adjusting device, which comprises a ball head 90 arranged on the cover plate 9 and a rotating seat 25 arranged at the bottom of the slot part 2, and the rotating seat 25 can rotate around the ball head 90 in all directions, so that the sticky board 3 can rotate to any angle as required, and the pitch adjustment relative to the cover plate 9 can be realized, that is, the tilt effect can be achieved, so as to be suitable for various use scenes.

The structure of the angle adjusting device is not limited to the above structure, and the angle of the sticky board 3 can be adjusted as required.

The seat body 1 is provided with more than one ultraviolet lamp source 5 for attracting mosquitoes, and the ultraviolet lamp source 5 can emit ultraviolet lamp of about 365 nanometers to attract mosquitoes.

In this embodiment, to achieve the best mosquito attraction effect, six ultraviolet lamp sources 5 are arranged around the slot part 2, and the specific positions are shown in FIG. 3.

A PCB board 6 is also arranged in the accommodating cavity, and the ultraviolet lamp source 5 is electrically connected with the PCB board 6. The ultraviolet lamp source 5 can be arranged on the upper seat body 10 or directly on the PCB board 6, and the ultraviolet lamp source 5 only needs to extend out of the upper seat body 10.

The seat body 1 is also provided with more than one illuminating lamp 7, which is electrically connected with the PCB board 7, and the PCB board 6 is also provided with a charging connector 61 and a power switch 62. A storage battery (not shown) electrically connected with the PCB board 6 is also provided in the accommodating cavity.

The upper seat body 10 is provided with a button 8 for pressing the power switch 62.

In this solution, the sticky board 3 is clamped by the first slot part 21 and the second slot part 22, and the sticky board 3 can be replaced by plugging and unplugging, which is very convenient; mixing the bait and adhesive together can simplify the structure of the solution and reduce the production cost; an angle adjusting device is arranged, so that the angle of the sticky board 3 can be adjusted as required, and the sticky board can be suitable for various use scenes; by arranging a plurality of ultraviolet lamp sources 5 around the slot part 2, the ultraviolet lamp sources 5 can attract mosquitoes by emitting ultraviolet lamp, thus achieving a better mosquito killing effect; the illuminating lamp 7 can achieve the effects of lighting and ambient light, and the switch 62 can switch different modes as needed to realize multiple functions. The battery in seat body 1 is charged through the charging connector 61, so the mosquito trap can be carried out and is suitable for outdoor scenes such as camping.

### Example 3

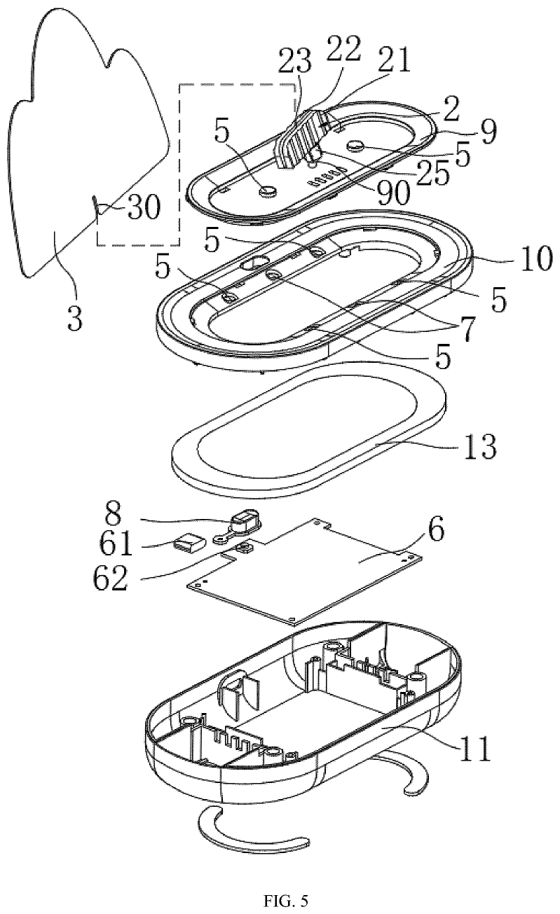

As shown in FIG. 5, a portable mosquito trap includes seat body 1 having an accommodating cavity.

In this embodiment, the seat body 1 includes an upper seat body 10 and a lower seat body 11, which are detachably connected, and the accommodating cavity is formed between the upper seat body 10 and the lower seat body 11, and the upper seat body 10 and the lower seat body 11 are connected by screws, the bottom of the lower seat body 11 is also provided with an anti-skid pad 110 for anti-skid.

Of course, the connection mode between the upper seat body 10 and the lower seat body 11 is not limited to the threaded connection mode, and the upper seat body 10 and the lower seat body 11 can be closely combined by a snap connection mode.

Slot part 22 is movably arranged on seat body 1, and slot part 2 is used for installing the sticky board 3 coated with an adhesive.

In this embodiment, the slot part 2 includes a first slot part 21 and a second slot part 22, and the sticky board 3 is clamped by the first slot part 21 and the second slot part 22. Since the sticky board 3 is usually made of paper and has certain compressibility, it is only necessary to reserve a distance between the first slot part 21 and the second slot part 22 that is less than the thickness of the sticky board 3, and when placing the sticky board 3, the sticky board 3 should be pressed hard. Of course, to have a better clamping effect of the slot part 2, elastic pieces can be arranged on the opposite surfaces of the first slot part 21 and the second slot part 22.

The slot 200 formed by the first slot part 21 and the second slot part 22 of the slot part 2 is straight. Of course, the shape of the slot 200 is not limited to straight, and it can be S-shaped, L-shaped and other desired line shapes, and it may also be round, oval, circular and other closed shapes; similarly, the sticky board 3 can also be of various shapes matching with the above clamping groove. When the sticky board 3 is of a circular shape, the surface area of the sticky board increases, and more mosquitoes can be adhered.

Slot 200 may be perpendicular to seat body 1 or inclined at an angle with respect to seat body 1.

Even, a sticky board installation boss can be arranged on the top of the slot part 2, and an installation hole matched with the sticky board installation boss can be formed on the sticky board 3, and the sticky board 3 can be laid flat on the top of the slot part 2.

In this embodiment, a positioning protrusion 23 for positioning the sticky board 3 is arranged between the first slot part 21 and the second slot part 22, and the positioning protrusion 23 extends from the top of the slot part 2 to the bottom of the slot part 2. The sticky board 3 is provided with a positioning groove 30, and when the sticky board 3 is installed, the positioning groove 30 is clamped into the positioning protrusion 23.

As part of the bait will volatilize completely after being left for a long time, in this embodiment, the bait and adhesive are mixed, which can simplify the structure of the solution and reduce the production cost.

In this embodiment, for the sake of beauty, a cover plate 9 which can transmit the light emitted by the ultraviolet lamp source 5 and the illuminating lamp 7 is also arranged on the upper part of the upper seat body 10, and the cover plate 9 is connected with the upper seat body 10 through threads or buckles.

In this embodiment, the slot part 2 is connected with the seat body 1 through an angle adjusting device, which comprises a ball head 90 arranged on the cover plate 9 and a rotating seat 25 arranged at the bottom of the slot part 2, and the rotating seat 25 can rotate around the ball head 90 in all directions, so that the sticky board 3 can rotate to any angle as required, and the pitch adjustment relative to the cover plate 9 can be realized, that is, the tilt effect can be achieved, so as to be suitable for various use scenes.

The structure of the angle adjusting device is not limited to the above structure, and the angle of the sticky board 3 can be adjusted as required.

The seat body 1 is provided with more than one ultraviolet lamp source 5 for attracting mosquitoes, and the ultraviolet lamp source 5 can emit ultraviolet lamp of about 365 nanometers to attract mosquitoes.

In this embodiment, to achieve the best mosquito attraction effect, six ultraviolet lamp sources 5 are arranged around the slot part 2, and the specific positions are shown in FIG. 3.

A PCB board 6 is also arranged in the accommodating cavity, and the ultraviolet lamp source 5 is electrically connected with the PCB board 6. The ultraviolet lamp source 5 can be arranged on the upper seat body 10 or directly on the PCB board 6, and the ultraviolet lamp source 5 only needs to extend out of the upper seat body 10.

The seat body is also provided with a heating source for heating the seat body 1 and the sticky board 3, and the heat generated by the heating source simulates the heat generated by the human body, so as to further attract mosquitoes and improve the mosquito killing effect of the trap.

In this embodiment, the heating source is an annular infrared heating ring 13 arranged inside the upper seat body 10, and the infrared heating ring 13 is electrically connected with the PCB board 6. This arrangement can directly heat the upper seat body 10, and the heating effect is good. Of course, the heating source is not limited to the infrared heating plate, but also can be metal heating wires, carbon fiber heating wires, ceramic heaters, and the like.

The seat body 1 is also provided with more than one illuminating lamp 7, which is electrically connected with the PCB board 7, and the PCB board 6 is also provided with a charging connector 61 and a power switch 62. A storage battery (not shown) electrically connected with the PCB board 6 is also provided in the accommodating cavity.

The upper seat body 10 is provided with a button 8 for pressing the power switch 62.

In this solution, the sticky board 3 is clamped by the first slot part 21 and the second slot part 22, and the sticky board 3 can be replaced by plugging and unplugging, which is very convenient; mixing the bait and adhesive together can simplify the structure of the solution and reduce the production cost; an angle adjusting device is arranged, so that the angle of the sticky board 3 can be adjusted as required, and the sticky board can be suitable for various use scenes; by arranging a plurality of ultraviolet lamp sources 5 around the slot part 2, the ultraviolet lamp sources 5 can attract mosquitoes by emitting ultraviolet lamp, thus achieving a better mosquito killing effect, by arranging the infrared heating ring 13, the seat body 1 and the sticky board 3 are heated to a temperature equivalent to the human body temperature, so that the mosquito attraction effect can be further improved; by arranging the illuminating lamp 7, the effects of lighting and ambient light can be realized; and by switching different modes as required through the power switch 62, various functions can be realized; the battery in the seat body 1 is charged through the charging connector 61, so the mosquito trap can be carried out and is suitable for outdoor scenes such as camping.

The technical means disclosed in the scheme of the present invention are not limited to the technical means disclosed in the above embodiments, but also include the technical scheme composed of any combination of the above technical features. For those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. The headings, lists, and numbering included herein are for ease of explanation only and are not meant to be limiting.

The various features and processes described above may be used independently of one another or may be combined in many ways. All combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A portable mosquito trap comprising a seat body with an accommodating cavity, wherein a slot part is arranged on the seat body, and the slot part is used for installing a sticky board coated with an adhesive; and
more than one storage chamber for containing bait is arranged in the seat body; the seat body is provided with a bait emitting hole communicated with the storage chamber, and the storage chamber and the bait emitting hole are arranged close to the slot part; and
The seat body is provided with more than one ultraviolet lamp source for attracting mosquitoes.

2. The portable mosquito trap according to claim 1, wherein the seat body comprises an upper seat body and a lower seat body, and the upper seat body and the lower seat body are detachably connected; and the accommodating cavity is formed between the upper seat body and the lower seat body, a PCB board is also arranged in the accommodating cavity, and the ultraviolet lamp source is electrically connected with the PCB board.

3. The portable mosquito trap according to claim 2, wherein the storage chamber is detachably arranged in the lower seat body; and there are two storage chambers that are respectively arranged at two ends of the seat body along a length direction; and the storage chamber has a drawer structure, and can be pushed in and pulled out on the seat body.

4. The portable mosquito trap according to claim 1, wherein the slot part comprises a first slot part and a second slot part, the sticky board is arranged between the first slot part and the second slot part, and a positioning projection for positioning the sticky board is arranged between the first slot part and the second slot part.

5. The portable mosquito trap according to claim 1, wherein a number of the ultraviolet lamp sources is six, and the ultraviolet lamp sources are arranged around the slot part; and the ultraviolet lamp source is located below the sticky board.

6. The portable mosquito trap according to claim 1, wherein the bait emitting holes are a plurality of circular holes arranged according to a certain rule, and the bait emitting holes are located below the sticky board.

7. The portable mosquito trap according to claim 2, wherein more than one illuminating lamp for illumination is also arranged on the seat body, and the illuminating lamp is electrically connected with the PCB board, and the PCB board is also provided with a charging connector and a power switch; and a storage battery electrically connected with the PCB board is also arranged in the accommodating cavity.

8. A portable mosquito trap, comprising a seat body with an accommodating cavity, wherein a movable slot part is arranged on the seat body, and the slot part is used for installing a sticky board coated with an adhesive, and a bait and the adhesive are mixed together; and the seat body is provided with more than one ultraviolet lamp source for attracting mosquitoes, and the ultraviolet lamp sources are arranged around the slot part.

9. The portable mosquito trap according to claim 8, wherein the seat body comprises an upper seat body and a lower seat body, the upper seat body and the lower seat body are detachably connected, and the accommodating cavity is formed between the upper seat body and the lower seat body; and a PCB board is also arranged in the accommodating cavity, and the ultraviolet lamp source is electrically connected with the PCB board.

10. The portable mosquito trap according to claim 8, wherein the slot part is connected with the seat body through an angle adjusting device; and the slot part comprises a first slot part and a second slot part, the sticky board is arranged between the first slot part and the second slot part, and a positioning projection for positioning the sticky board is arranged between the first slot part and the second slot part.

11. The portable mosquito trap according to claim 10, wherein the seat body further comprises a cover plate arranged on an upper seat body, and one end of the angle adjusting device is connected with the cover plate; and the other end of the angle adjusting device is connected with the slot part.

12. The portable mosquito trap according to claim 9, wherein a number of the ultraviolet lamp sources is six, and the ultraviolet lamp sources are located below the sticky board.

13. The portable mosquito trap according to claim 10, wherein there are more than one illuminating lamps on the seat body, which are electrically connected with a PCB board, and the PCB board is also provided with a charging connector and a power switch; and a storage battery electrically connected with the PCB board is also arranged in the accommodating cavity.

14. A portable mosquito trap, comprising a seat body with an accommodating cavity, wherein a movable slot part is arranged on the seat body, and the slot part is used for installing a sticky board coated with an adhesive; and a bait for attracting mosquitoes is arranged on the sticky board; and the seat body is provided with more than one ultraviolet lamp source and a heating source for attracting mosquitoes, and the ultraviolet lamp source is arranged around the slot part; and the heating source is used for heating the seat body and the sticky board.

15. The portable mosquito trap according to claim 14, wherein the seat body comprises an upper seat body and a lower seat body, and the upper seat body and the lower seat body are detachably connected, and the accommodating cavity is formed between the upper seat body and the lower seat body; and a PCB board is also arranged in the accommodating cavity, and the ultraviolet lamp source is electrically connected with the PCB board.

16. The portable mosquito trap according to claim 14, wherein the slot part comprises a first slot part and a second slot part, the sticky board is arranged between the first slot part and the second slot part, and a positioning projection for positioning the sticky board is arranged between the first slot part and the second slot part.

17. The portable mosquito trap according to claim 14, wherein a number of the ultraviolet lamp sources is six, and the ultraviolet lamp sources are located below the sticky board.

18. The portable mosquito trap according to claim 15, wherein there are more than one illuminating lamps on the seat body, which are electrically connected with the PCB board, and the PCB board is also provided with a charging connector and a power switch; and a storage battery electrically connected with the PCB board is also arranged in the accommodating cavity.

19. The portable mosquito trap according to claim 15, wherein the heating source is an infrared heating plate, and the infrared heating plate is electrically connected with the PCB board.
